(19) United States
(12) Patent Application Publication
(10) Pub. No.: US 2026/0074876 A1
(43) Pub. Date: Mar. 12, 2026

(54) METHODS, ARCHITECTURES, APPARATUSES AND SYSTEMS FOR SUBBAND NON-OVERLAPPING FULL DUPLEX CONFIGURATION

(71) Applicant: InterDigital Patent Holdings, Inc., Wilmington, DE (US)

(72) Inventors: Jonghyun Park, Syosset, NY (US); Moon-il Lee, Meliville, NY (US); Nazli Khan Beigi, Longueuil (CA); Paul Marinier, Brossard (CA)

(21) Appl. No.: 19/116,280

(22) PCT Filed: Sep. 26, 2023
(86) PCT No.: PCT/US2023/033667

§ 371 Date: Mar. 27, 2025

Related U.S. Application Data
(60) Provisional application No. 63/410,723, filed on Sep. 28, 2022.
(60) Provisional application No. 63/421,617, filed on Nov. 2, 2022.
(60) Provisional application No. 63/464,993, filed on May 9, 2023.

(51) Int. Cl. H04L 5/14; H04L 5/00; H04W 24/10

(52) U.S. Cl. CPC H04L 5/14; H04L 5/0094; H04W 24/10

(57) ABSTRACT

Procedures, methods, architectures, apparatuses, systems, devices, and computer program products for measurements in wireless systems. A Wireless Transfer/Receive Unit, WTRU, receives information indicative of an uplink, UL, subband, SB, receives an indication to perform a measurement on a first set of resource blocks, RBs, and a first set of symbols, wherein the first set of symbols include a first one or more subband non-overlapping full duplex, SBFD, symbol, on condition that the first set of RBs includes both RBs in the UL SB and RBs outside the UL SB, determines a first measurement for the RBs in the first set of RBs that are in the UL SB and at least one additional measurement for at least one RB in the first set of RBs that are outside the UL SB, and transmits a message including the first measurement and the at least one additional measurement.

### CROSS-REFERENCE TO EARLIER APPLICATIONS

This application claims the benefit of U.S. Provisional Applications No. 63/410,723, filed Sep. 28, 2022, 63/421,617, filed Nov. 2, 2022, and 63/464,993, filed May 9, 2023, which are incorporated herein by reference in their entirety.

### BACKGROUND

The present disclosure is generally directed to the fields of communications, software and encoding, including, for example, to methods, architectures, apparatuses, systems directed to measurements in wireless systems.

### SUMMARY

In a first aspect, the present principles are directed to a Wireless Transmit/Receive Unit, WTRU, configured to receive information indicative of an uplink, UL, subband, SB, receive an indication to perform a measurement on a first set of resource blocks, RBs, and a first set of symbols, wherein the first set of symbols include a first one or more subband non-overlapping full duplex, SBFD, symbol, on condition that the first set of RBs includes both RBs in the UL SB and RBs outside the UL SB, determine a first measurement for the RBs in the first set of RBs that are in the UL SB and at least one additional measurement for at least one RB in the first set of RBs that are outside the UL SB, and transmit a message including the first measurement and the at least one additional measurement.

In a second aspect, the present principles are directed to a method at a Wireless Transfer/Receive Unit, WTRU, comprising receiving information indicative of an uplink, UL, subband, SB, receiving an indication to perform a measurement on a first set of resource blocks, RBs, and a first set of symbols, wherein the first set of symbols include a first one or more subband non-overlapping full duplex, SBFD, symbol, on condition that the first set of RBs includes both RBs in the UL SB and RBs outside the UL SB, determining a first measurement for the RBs in the first set of RBs that are in the UL SB and at least one additional measurement for at least one RB in the first set of RBs that are outside the UL SB, and transmitting a message including the first measurement and the at least one additional measurement.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates slot format for normal cyclic prefix according to Table 11.1.1-1 in TS38.213;

FIG. 3 illustrates a NR TDD framework based on FD-gNB and HD-UEs in a cell according to NR Rel. 18;

FIG. 4 illustrates subband non-overlapping FD-gNB and HD-UEs in a cell;

FIG. 5 illustrates an example of subband non-overlapping full duplex (SBFD) configuration;

FIG. 6 illustrates an example for SBFD based on single Bandwidth Part (BWP) for Time Division Duplex (TDD) format DDDSU;

FIG. 7 illustrates an example of SBFD based on multiple BWP;

FIGS. 8 and 9 illustrate an example of relative bandwidths of bandwidth pairs; and

FIG. 10 illustrates an example of CLI measurement on an UL subband.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

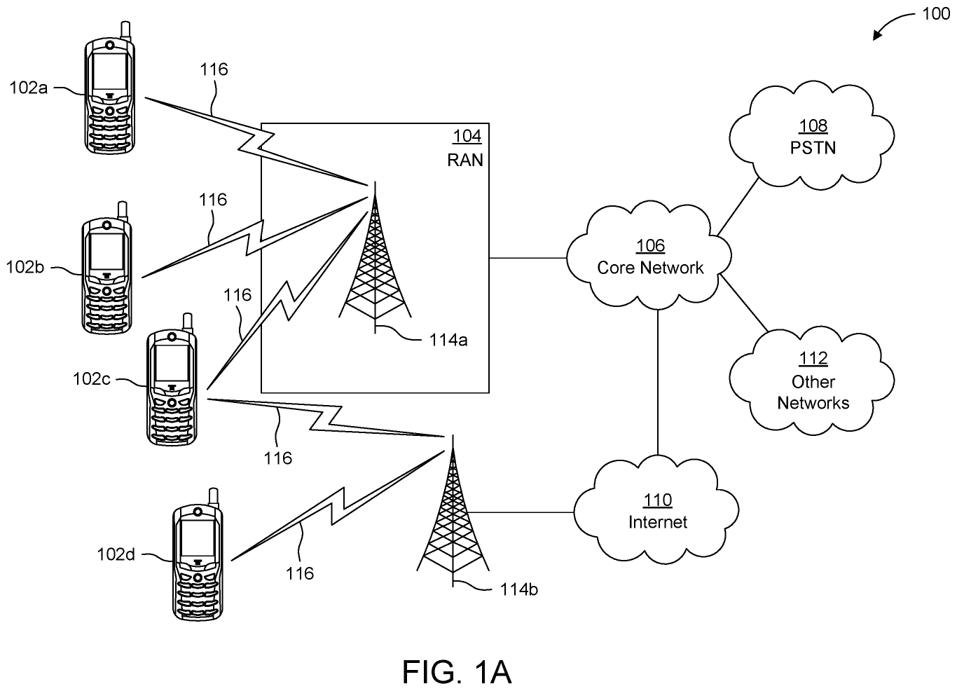

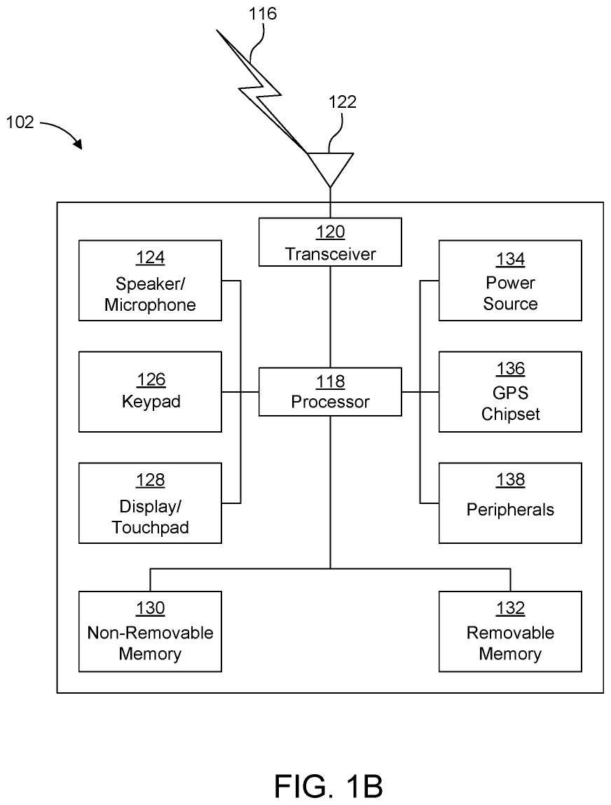

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit the applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### Introduction

NR supports dynamic/flexible time division duplex (TDD) based on a slot format indicator (SFI) that can be indicated to a group of UEs by a group-common (GC) Downlink Control Information (DCI) (format 2_0). In addition, semi-static configurations via a higher-layer parameter of ‘tdd-UL-DL-config-common’ and ‘tdd-UL-DL-config-dedicated’ can be configured, where the transmission pattern for each slot/symbol can be configured as either of ‘D’ as downlink, ‘U’as uplink, and ‘F’as flexible.

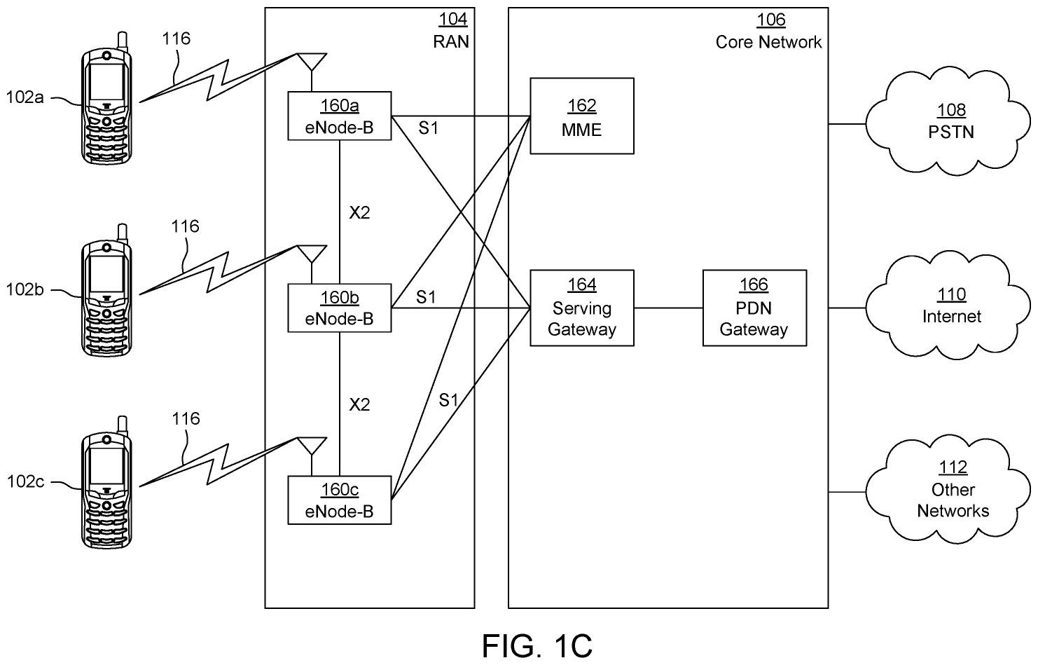

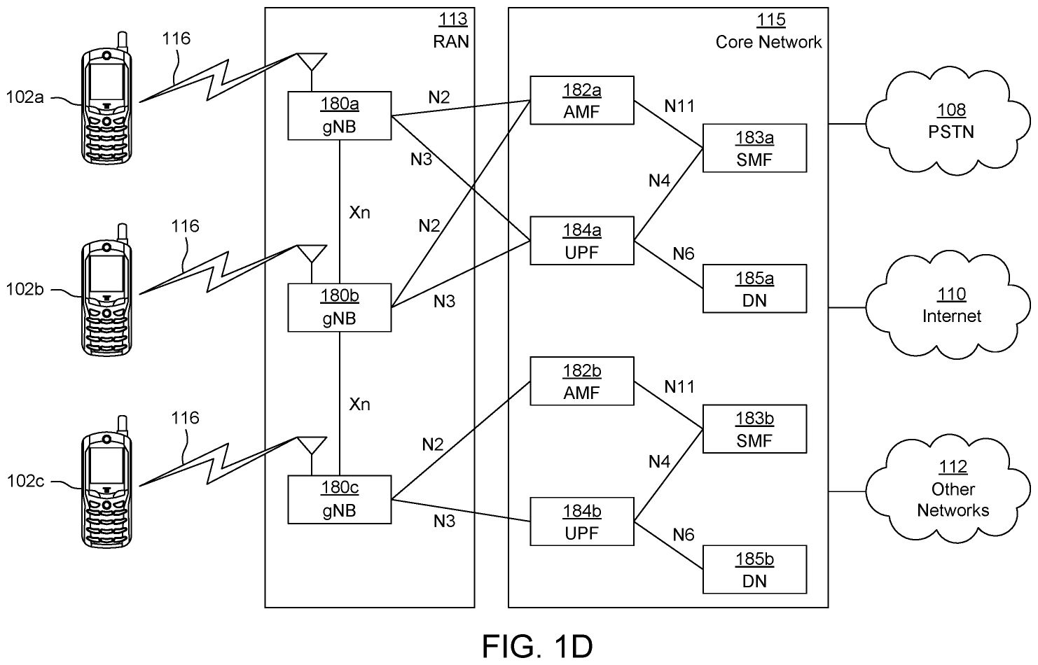

Up to NR Rel-17, most practical assumptions for duplexing are half duplex (HD) for both gNB and UE. In Rel-18, enhancements to support full duplex (FD) at least for gNB, as shown in FIG. 3, have been proposed. Moreover, subband non-overlapping full duplex (SBFD), a.k.a. cross division duplex (XDD), as illustrated in FIG. 4, has been identified as a promising approach offering reduced FD implementation complexity in terms of cancelling self-interference (SI) and mitigating cross-link interference (CLI), at least at the gNB side.

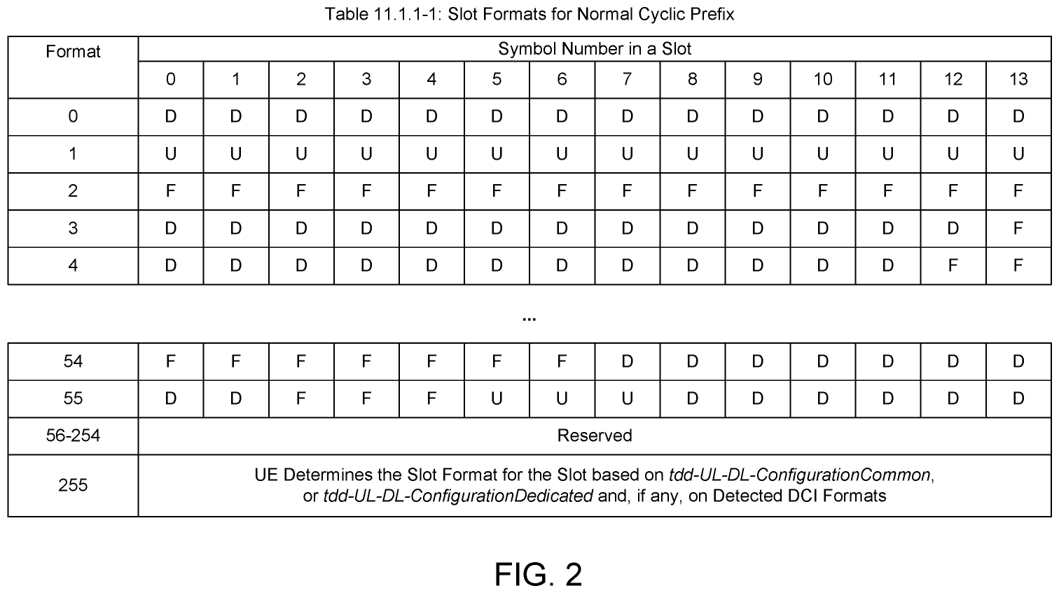

The SBFD scenario could be a foundation for improving conventional TDD operation by enhancing UL coverage, improving capacity, reducing latency, and so forth. In FIG. 5 illustrates an example SBFD configuration where a UL subband (SB) can be allocated in a ‘D’ slot (and/or ‘F’slot). As another example, a DL subband may be allocated in a ‘U’slot (and/or ‘F’slot).

However, in case semi-static configuration is used for the time and frequency-domain configurations (e.g., RBs and/or subbands for SBFD) in SBFD operation based on a single Bandwidth Part (BWP) pair (e.g., RB-set based SBFD), this may result in one or more of the following issues, while it may have benefits in terms of hardware-wise complexity reduction (e.g., pre-set RF range for Tx/Rx) via a simplified SBFD configuration:
Resource waste, e.g., one or more TDD directions (e.g., UL or DL) may not have enough traffic (e.g., due to varying traffic), and configuring semi-static resource allocations may result in resources not being used efficiently.
Increased latency, e.g., one or more of the TDD directions configured in SBFD (e.g., UL or DL) may have heavy traffic (e.g., high load), in which case the semi-static configuration for the time and frequency-domain (e.g., RBs and/or subbands for SBFD) may result in increased latency.
Reduced flexibility, e.g., without dynamic-enabled configurations, the scheduling and resource allocations in SBFD may experience lower flexibility in cases with varying traffic and demands (e.g., due to semi-static configuration for the time and frequency-domain (e.g., RBs and/or subbands for SBFD)).
Increased complexity, e.g., the semi-static configuration for the time and frequency-domain (e.g., RBs and/or subbands for SBFD) may result in increased complexity in scheduling. As such, due to the fixed/static configuration of the UL and/or DL subbands or PRBs in SBFD, the scheduling complexity may increase.

In case a dynamic SBFD configuration updating/switching is used, there may be a need for a network-side (including neighboring gNBs) coordination for having a secured/planned subband allocations for a time-given duration for a cross-layer-interference (CLI) measurement and reporting from one or more UEs.

### Overview

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A sign, symbol, or mark of forward slash ‘/’ is to be interpreted as ‘and/or’ unless particularly mentioned otherwise, where for example, ‘A/B’may imply ‘A and/or B’.

Herein, the term ‘subband’ is used to refer to a frequency-domain resource and may be characterized by at least one of the following: a set of resource blocks (RBs), a set of resource block sets (RB sets), e.g. when a carrier has intra-cell guard bands, a set of interlaced resource blocks, a bandwidth part or portion thereof, and a carrier or portion thereof.

For example, a subband may be characterized by a starting RB and number of RBs for a set of contiguous RBs within a bandwidth part. A subband may also be defined by the value of a frequency-domain resource allocation field and bandwidth part index.

Herein, the term ‘XDD’ is used to refer to a subband-wise duplex (e.g., either UL or DL being used per subband) and may be characterized by at least one of the following:
Cross Division Duplex (e.g., subband-wise FDD within a TDD band);
subband-based full duplex (e.g., full duplex as both UL and DL are used/mixed on a symbol/slot, but either UL or DL being used per subband on the symbol/slot);
Frequency-domain multiplexing (FDM) of DL/UL transmissions within a TDD spectrum;
subband non-overlapping full duplex (SBFD) (e.g., non-overlapped sub-band full-duplex);
full duplex other than a same-frequency (e.g., spectrum sharing, subband-wise-overlapped) full duplex; and
an advanced duplex method, e.g., other than (pure) TDD or FDD

Herein, the term “dynamic(/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier (CC) or a bandwidth part (BWP) may have one single type among ‘D’, ‘U’, and ‘F’ on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first UE being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second UE being communicated/associated with the second gNB based on a second SFI and/or tdd-UL-DL-config configured/indicated by the second gNB. In an example, the first UE may determine that the reception of the downlink signal is being interfered by the uplink signal, where the interference caused by the uplink signal may refer to a UE-to-UE cross-layer interference (CLI).

### Definition of Beam

A UE may transmit or receive a physical channel or reference signal according to at least one spatial domain filter. The term ‘beam’may be used to refer to a spatial domain filter.

The UE may transmit a physical channel or signal using the same spatial domain filter as the spatial domain filter used for receiving an RS (such as CSI-RS) or a SS block. The UE transmission may be referred to as “target”, and the received RS or SS block may be referred to as “reference” or “source”. In such case, the UE may be said to transmit the target physical channel or signal according to a spatial relation with a reference to such RS or SS block.

The UE may transmit a first physical channel or signal according to the same spatial domain filter as the spatial domain filter used for transmitting a second physical channel or signal. The first and second transmissions may be referred to as “target” and “reference” (or “source”), respectively. In such case, the UE may be said to transmit the first (target) physical channel or signal according to a spatial relation with a reference to the second (reference) physical channel or signal.

A spatial relation may be implicit, configured by RRC or signaled by MAC CE or DCI. For example, a UE may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The UE may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the UE is configured with a quasi-colocation (QCL) assumption type D between corresponding antenna ports. Such association may be configured as a transmission configuration indicator (TCI) state. A UE may be indicated an association between a CSI-RS or SS block and a DM-RS by an index to a set of TCI states configured by RRC and/or signaled by MAC CE. Such indication may also be referred to as a “beam indication”.

### TRP, MTRP, M-TRP

Herein, the term ‘TRP’ (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS). Herein, Multi-TRP may be interchangeably used with one or more of MTRP, M-TRP, and multiple TRPs, but still consistent with this invention.

### CSI Components

A UE may report a subset of channel state information (CSI) components, where CSI components may correspond to at least a CSI-RS resource indicator (CRI), a SSB resource indicator (SSBRI), an indication of a panel used for reception at the UE (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

### Channel and/or Interference Measurements

A UE may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The UE may monitor, receive, or attempt to decode an SSB during initial access, initial synchronization, radio link monitoring (RLM), cell search, cell switching, and so forth.

A UE may measure and report the channel state information (CSI), wherein the CSI for each connection mode may include or be configured with one or more of following:
CSI Report Configuration, including one or more of the following;
   CSI report quantity, e.g., Channel Quality Indicator (CQI), Rank Indicator (RI), Precoding Matrix Indicator (PMI), CSI-RS Resource Indicator (CRI), Layer Indicator (LI), etc.;
   CSI report type, e.g., aperiodic, semi persistent, periodic;
   CSI report codebook configuration, e.g., Type I, Type II, Type II port selection, etc.;
   CSI report frequency; and
CSI-RS (Resource Set), including one or more of the following CSI Resources:
   NZP-CSI-RS Resource for channel measurement, where NZP stands for non-zero-power;
   NZP-CSI-RS Resource for interference measurement; and
   CSI-IM Resource for interference measurement; and
NZP CSI-RS Resources, including one or more of the following:
   NZP CSI-RS Resource ID;
   Periodicity and offset;
   QCL Info and TCI-state; and
   Resource mapping, e.g., number of ports, density, CDM type, etc.

A UE may indicate, determine, or be configured with one or more reference signals. The UE may monitor, receive, and measure one or more parameters based on the respective reference signals. For example, one or more of the following may apply. The following parameters-SS-RSRP, CSI-RSRP, SS-SINR, CSI-SINR, RSSI, CLI-RSSI and SRS-RSRP-are non-limiting examples of the parameters that may be included in reference signal(s) measurements. One or more of these parameters may be included. Other parameters may be included.

SS-RSRP, SS reference signal received power, may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS-SINR, SS signal-to-noise and interference ratio, may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

RSSI, Received signal strength indicator, may be measured based on the average of the total power contribution in configured OFDM symbols and bandwidth. The power contribution may be received from different resources (e.g., co-channel serving and non-serving cells, adjacent channel interference, thermal noise, and so forth)

CLI-RSSI, Cross-Layer interference received signal strength indicator, may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

SRS-RSRP, Sounding reference signals RSRP, may be measured based on the linear average over the power contribution of the resource elements (RE) that carry the respective SRS.

Herein, a property of a grant or assignment may include at least one of the following:
a frequency allocation;
an aspect of time allocation, such as a duration;
a priority;
a modulation and coding scheme;
a transport block size;
a number of spatial layers;
a number of transport blocks;
a TCI state, CRI or SRI;
a number of repetitions;
whether the repetition scheme is Type A or Type B;
whether the grant is a configured grant type 1, type 2 or a dynamic grant;
whether the assignment is a dynamic assignment or a semi-persistent scheduling (configured) assignment;
a configured grant index or a semi-persistent assignment index;
a periodicity of a configured grant or assignment;
a channel access priority class (CAPC); and
any parameter provided in a DCI, by MAC or by RRC for the scheduling the grant or assignment.

Herein, an indication by DCI may include at least one of the following:
An explicit indication by a DCI field or by RNTI used to mask CRC of the PDCCH.
An implicit indication by a property such as DCI format, DCI size, Coreset or search space, Aggregation Level, first resource element of the received DCI (e.g., index of first Control Channel Element), where the mapping between the property and the value may be signaled by RRC or MAC.

Herein, the term ‘signal’may be interchangeably used with one or more of following:
Sounding reference signal (SRS);
Channel state information-reference signal (CSI-RS);
Demodulation reference signal (DM-RS);
Phase tracking reference signal (PT-RS); and
Synchronization signal block (SSB).

Herein, the term ‘channel’ may be interchangeably used with one or more of following:
Physical downlink control channel (PDCCH);
Physical downlink shared channel (PDSCH);
Physical uplink control channel (PUCCH);
Physical uplink shared channel (PUSCH);
Physical random access channel (PRACH);
etc.

Herein, the expression “downlink reception” may be used interchangeably with Rx occasion, PDCCH, PDSCH, SSB reception.

Herein, the expression “uplink transmission” may be used interchangeably with Tx occasion, PUCCH, PUSCH, PRACH, SRS transmission.

Herein, the expression ‘RS’ may be interchangeably used with one or more of RS resource, RS resource set, RS port and RS port group.

Herein, the expression ‘RS’ may also be interchangeably used with one or more of SSB, CSI-RS, SRS and DM-RS.

Herein, the expression “time instance” may be interchangeably used with slot, symbol, subframe.

Herein, the expressions “UL-only and DL-only Tx/Rx occasions” may interchangeably be used with legacy TDD UL or legacy TDD DL, respectively. In an example, the legacy TDD UL/DL Tx/Rx occasions may be the cases where SBFD is not configured and/or where SBFD is disabled.

### 1 SBFD Configuration Updates for Advanced Duplex Operation

### 1.1 SBFD Subband Granularity

SBFD Configuration based on a Single BWP (e.g., RB-Set Based SBFD)

For an SBFD operation scenario, a single configured DL and UL BWP pair may be used. A UE may be configured with one or more BWPs for a component carrier (CC) (or cell), where each BWP may be indexed with a BWP-ID, e.g., 0, 1, 2, or 3. The UE may receive (from a gNB) a SBFD configuration comprising at least time and/or frequency domain for DL/UL subband location information, where the SBFD configuration may be associated with a BWP-ID X, e.g., X=0, 1, 2, or 3. The SBFD configuration may be indicated/configured in the CC/cell level (e.g., along with the CC/cell configuration) or in a system information block (SIB) and/or in a master information block (MIB). In an example, the UE may receive the SBFD configuration for the CC (or cell), and the UE may determine that a BWP (e.g., DL/UL BWP pair) associated with the BWP-ID X is an active BWP, e.g., in response to determining the BWP is a default BWP and/or an initial BWP (e.g., after a RACH procedure), or in response to receiving a DCI indicating which BWP-ID becomes an active BWP (e.g., via a ‘Bandwidth part indicator’ field in the DCI, as a BWP switching behavior), etc. The UE may determine the BWP with the BWP-ID X comprises at least one subband (e.g., UL subband(s) and/or DL subband(s)) within the BWP. In response to the determining, the UE may identify/determine that the SBFD configuration (e.g., comprising the at least one subband) is associated with the BWP-ID X.

A UE (e.g., a SBFD-enabled UE) may receive or be configured with one or more SBFD UL or DL subbands in one or more time-instances, where the subbands may be associated with a BWP-ID X (e.g., X=0, 1, 2, or 3), e.g., and/or a CC/cell. The time instances may be (initially and/or previously) configured with a first TDD direction (e.g., downlink), a second TDD direction (e.g., uplink), or a third TDD direction (e.g., Flexible). The configuration as DL, UL, or flexible may be based on one or more TDD UL/DL configurations the UE receives, such as a common TDD UL/DL configuration (e.g., tdd-UL-DL-ConfigurationCommon), a dedicated TDD UL/DL configuration (e.g., tdd-UL-DL-ConfigurationDedicated), and/or a slot format indicator (SFI) (e.g., a dynamically indicated SFI, e.g., via DCI).

The UE may be configured with one or more resource allocations for SBFD subbands. The SBFD configuration may include a flag signal (e.g., enabled/disabled), where for example one value (e.g., the value of zero (0)) indicates no SBFD configuration (e.g., SBFD not enabled), and another value (e.g., the value of one (1)) may indicate SBFD configuration enabled. The SBFD configurations may be indicated via a system information block (SIB), semi-statically (e.g., via RRC), dynamic (e.g., via MAC-CE, DCI), and so forth. The UE may receive an indication of the time resources (e.g., one or more symbols, slots, and so forth), for which the SBFD is applicable for a serving cell, carrier or BWP.

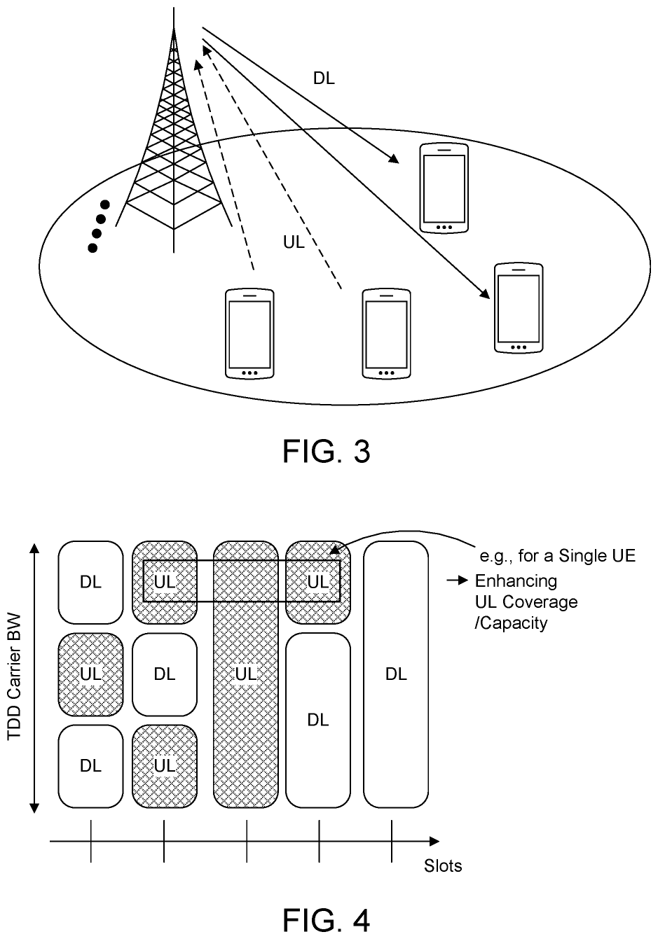

The UE may receive the frequency resources (e.g., subbands or one or more sets of PRBs) within a BWP (e.g., BWP-ID X) and/or a CC/cell for which the SBFD is configured. FIG. 6 illustrates an example for SBFD based on single BWP for TDD format DDDSU (where each letter corresponds to a slot starting with slot n, and ‘D’ stands for downlink, ‘S’ for special or ‘flexible’ slot, and ‘U’ for uplink), where the SBFD is configured based on one or more sets of PRBs. As can be seen, slot n is a DL slot, slots n+1 and n+2 are DL slots including UL subbands, slot n+3 is a special slot including a UL subband, and slot n+4 is a UL slot. The time instances (e.g., slots, symbols) configured for SBFD may be indicated based on periodic, semi-persistent, or aperiodic configurations. In an example, the time instances may be indicated via an explicit configuration (e.g., a bitmap configuration), e.g., within a period in the time-domain, where the period (e.g., time-interval, time window, periodicity, etc.) may be pre-defined (e.g., T ms), pre-configured, or indicated to the UE.

In an example, a UE may be configured with a DL TDD configuration (e.g., with DL slot(s)/symbol(s)) for a BWP for one or more Rx occasions (e.g., via tdd-UL-DL-config-common/dedicated configurations, SFI, and so forth). The UE may receive or be configured with SBFD operation as part of the TDD configuration in the respective time instance. As such, if the SBFD is configured, the configured frequency resources (e.g., subbands and/or PRBs) may be configured for UL channels/Tx occasions.

In another example, the UE may be configured with an UL TDD configuration (e.g., with UL slot(s)/symbol(s)) for a BWP for one or more Tx occasions. The UE may further receive or be configured with SBFD operation as part of the TDD configuration in the respective time instance. As such, if the SBFD is configured, the configured frequency resources (e.g., subbands and/or PRBs) may be configured for DL channels/Rx occasions.

In another example, the UE may be configured with a Flexible TDD configuration for a BWP for one or more Rx/Tx occasions. The UE may receive or be configured with SBFD operation as part of the TDD configuration in the respective time instance. As such, if the SBFD is configured, the configured frequency resources (e.g., subbands and/or PRBs) may be configured for either UL transmission or DL reception based on the configurations.

The duplexing mode for SBFD configuration (UL/DL) may be indicated via a flag, where for example a first value (e.g., zero (0)) may indicate UL duplexing mode, and a second value (e.g., one (1)) may indicate DL duplexing mode.

The SBFD duplexing mode configuration/flag may be configured as part of SBFD configuration that can be semi-static (e.g., via RRC) or dynamic (e.g., via DCI, MAC-CE).

The SBFD duplexing mode configuration/flag may be configured as part of resource allocation configuration for a Tx/Rx occasion.

### SBFD Operation Within Multiple BWP Pairs

For an SBFD operation scenario, multiple configured DL and UL BWP pairs may be used. A UE may be configured with one or more BWPs for a CC (or cell), where each BWP may be indexed with a BWP-ID, e.g., 0, 1, 2, or 3. The UE may receive (from a gNB) an SBFD configuration at least comprising one or more pairs as follows:
a first pair of {BWP-ID X, ‘DL’ (as a selected link direction for SBFD SB)}, and/or
a second pair of {BWP-ID Y, ‘UL’ (as a selected link direction for SBFD SB)}, and/or
a third pair of {BWP-ID Z, ‘DL’ (as a selected link direction for SBFD SB)}, etc.

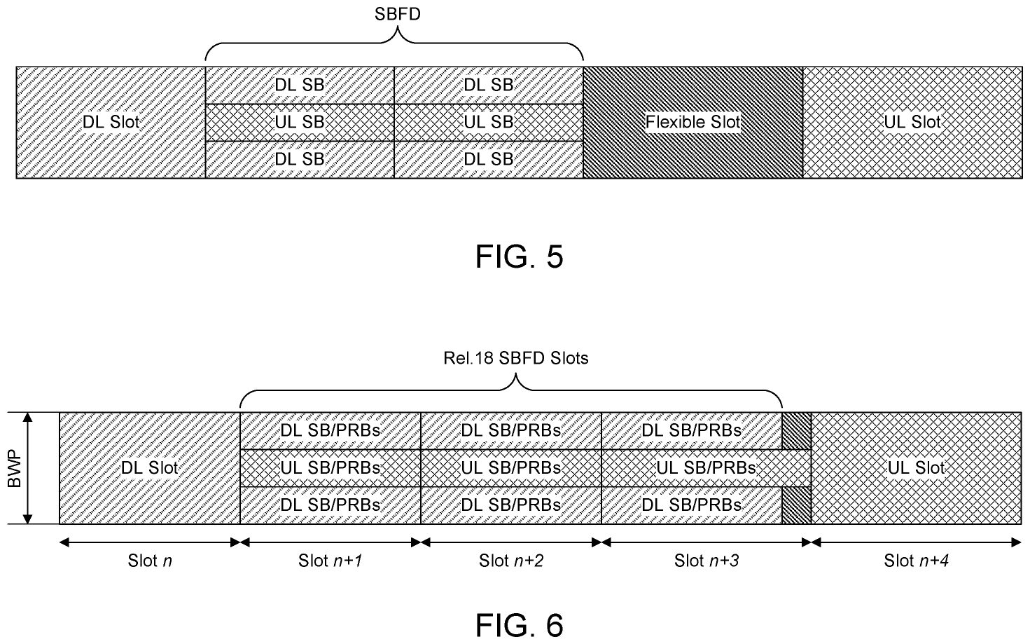

FIG. 7 illustrates an example of SBFD based on multiple BWP, where SBFD is configured based on TDD configuration for one or more BWPs. For example, in FIG. 7, BWPs with BWP-ID (e.g., x and x+2) are configured as DDDSU, whereas BWP with BWP-ID (e.g., x+1) is configured as DUUUU.

In an example, the selected link direction for SBFD SB may be ‘DL+UL’ associated with a BWP-ID, where it may imply that the BWP with the BWP-ID comprises both DL SB and UL SB in a SBFD slot/symbol.

In an example, the selected link direction for SBFD SB may be ‘at least DL’ associated with a BWP-ID, where it may imply that the BWP with the BWP-ID comprises at least DL SB (and UL SB being initially unknown) in a SBFD slot/symbol. The UL SB being initially unknown may imply the UE may receive a scheduling/configured grant for UL transmission in the BWP with the BWP ID (associated with the ‘at least DL’) and may perform the UL transmission if no collision/overlap with an actual DL reception is found/determined in the SBFD slot/symbol.

In an example, the selected link direction for SBFD SB may be ‘at least UL’ associated with a BWP-ID, where it may imply that the BWP with the BWP-ID comprises at least UL SB (and DL SB being initially unknown) in a SBFD slot/symbol. The DL SB being initially unknown may imply the UE may receive a scheduling/configured grant for DL reception in the BWP with the BWP ID (associated with the ‘at least UL’) and may perform the DL reception if no collision/overlap with an actual UL transmission is found/determined in the SBFD slot/symbol.

### 1.2 Timeline on SBFD Configuration Updates with BWP Switching

In an embodiment, a UE may be configured with (at least) one (RB-set-based) SBFD configuration per (DL/UL) BWP pair (associated with a BWP-ID) or CC/cell, and along with a BWP switching command (received at the UE) for switching from a first BWP pair to a second BWP pair, the UE may determine whether and/or how to change an associated SBFD configuration for the second BWP pair. One or more of following examples and operations may apply.

In an example, the UE may be configured with one or more BWPs for a CC (or cell), where each BWP may be indexed/configured with a BWP-ID X, e.g., X=0, 1, 2, or 3. The UE may receive (from a gNB) a first SBFD configuration, at least comprising a first time and/or frequency domain DL/UL subband location information, e.g., associated with a first (DL/UL) BWP pair with BWP-ID 1 (e.g., X=1 out of {0, 1, 2, 3}), and/or associated with the CC/cell, where the first BWP pair with BWP-ID 1 may be a default BWP (and/or an initial BWP). In an example, the first BWP pair may not be directly/explicitly configured/associated with the first SBFD configuration, and the UE may determine that the first SBFD configuration (e.g., configured/associated with the CC/cell) is applicable the first BWP pair (with BWP-ID 1), e.g., by default, or as a pre-determined condition/rule. The UE may receive (from a gNB) a second SBFD configuration, at least comprising a second time and/or frequency domain DL/UL subband location information, associated with a second (DL/UL) BWP pair with BWP-ID 2 (e.g., X=2 out of {0, 1, 2, 3}).

In an example, the UE may identify/determine a current BWP as BWP-ID 1, where the BWP-ID 1 may be indicated by the most recent DCI comprising a ‘Bandwidth part indicator’ field indicating a value/codepoint for ‘BWP-ID=1’ or the UE may obtain/determine that the current BWP is BWP-ID 1 based on a rule-based behavior, e.g., by a pre-defined mechanism based on a parameter of ‘initial-BWP’ and/or ‘default-BWP’.

In an example, the UE may receive, at a first slot (or symbol), a BWP switching command (e.g., via a DCI, a UL-related DCI format 0_1, a UL-related DCI format 0_2, a DL-related DCI format 1_1, or a DL-related DCI format 1_2, etc.) indicating a BWP-ID set to 2. The BWP switching command may be the ‘Bandwidth part indicator’ field, or be a separate/new field, or be based on an independent/new indication mechanism. The UE may identify/determine the current BWP (e.g., with BWP-ID 1) is to be switched to an indicated BWP with BWP-ID 2 at a T(>=0) slot(s) (or symbol(s)) after the first slot (or symbol), where the value of T may be determined by a pre-defined rule, e.g., based on a parameter for subcarrier spacing and/or UE capability for BWP switch delay, etc. In an example, the UE may identify/determine T=5 based on the UE's capability reporting and a pre-defined BWP switch delay related rule. In response to receiving the BWP switching command at the first slot (or symbol), the UE may perform an active BWP switching from the current (DL/UL) BWP pair with BWP-ID 1 to a new (DL/UT) BWP pair with the indicated BWP-ID 2 at a second slot (or symbol) which may be calculated/determined as the first slot (or symbol)+T slot(s) (or symbol(s)).

Based on the active BWP switching, e.g., at the second slot (or symbol), the UE may determine whether and/or how to change an associated SBFD configuration as well along with the BWP switching, based on applying at least one of the following operations:
Operation 1: Based on which DCI format (or type or field/contents, etc.) is received, which delivers the BWP switching command, the UE may determine whether to change/switch an associated SBFD configuration along with the BWP switching.

In an example, when a UE operates in the first BWP pair with BWP-ID 1 and is operated based on the first SBFD configuration, in response to receiving a UL-related DCI (e.g., format 0_1, 0_2) comprising the BWP switching command indicating to switch to the second BWP pair with BWP-ID 2, the UE may determine to change/switch an associated SBFD configuration (as well) to the second SBFD configuration, e.g., which is associated with the second BWP pair with BWP-ID 2. If the UE then receives a DL-related DCI (e.g., format 1_1, 1_2, or other than UL-DCI, etc.) comprising the BWP switching command indicating to switch to the second BWP pair with BWP-ID 2, the UE may determine to maintain (e.g., not change, retain, continue to use) the first SBFD configuration (e.g., in terms of UL subband location) but change a BWP pair (from the first BWP pair) to the second BWP pair with BWP-ID 2. This may provide benefits in terms of resource utilization flexibility and efficiency in that a SBFD configuration is not frequently changed but is changed selectively depending on gNB signaling, which may reduce gNB implementation complexity by avoiding frequent RF (e.g., RF filter, filtering, filtering coefficients) switching at gNB.

In an example, when a UE operates in the first BWP pair with BWP-ID 1 and is operated based on the first SBFD configuration, in response to receiving a DL-related DCI (e.g., format 1_1, 1_2) comprising the BWP switching command indicating to switch to the second BWP pair with BWP-ID 2, the UE may determine to change/switch an associated SBFD configuration (as well) to the second SBFD configuration, e.g., which is associated with the second BWP pair with BWP-ID 2. If the UE then receives a UL-related DCI (e.g., format 0_1, 0_2, or other than DL-DCI, etc.) comprising the BWP switching command indicating to switch to the second BWP pair with BWP-ID 2, the UE may determine to maintain (e.g., not change, retain, continue to use) the first SBFD configuration (e.g., in terms of UL subband location) but change a BWP pair (from the first BWP pair) to the second BWP pair with BWP-ID 2. This may provide benefits in terms of resource utilization flexibility and efficiency in that a SBFD configuration is not frequently changed but is changed selectively depending on gNB signaling, which may reduce gNB implementation complexity by avoiding frequent RF (e.g., RF filter, filtering, filtering coefficients) switching at gNB.

In an example, when a UE operates in the first BWP pair with BWP-ID 1 and is operated based on the first SBFD configuration, in response to receiving a DCI, based on a first RNTI (or other DCI-related type or field/contents, etc.), comprising the BWP switching command indicating to switch to the second BWP pair with BWP-ID 2, the UE may determine to change/switch an associated SBFD configuration (as well) to the second SBFD configuration, e.g., which is associated with the second BWP pair with BWP-ID 2. If the UE receives a DCI, based on a second RNTI (e.g., other than the first RNTI, or other DCI-related type or field/contents, etc.) comprising the BWP switching command indicating to switch to the second BWP pair with BWP-ID 2, the UE may determine to maintain (e.g., not change, retain, continue to use) the first SBFD configuration (e.g., in terms of UL subband location) but change a BWP pair (from the first BWP pair) to the second BWP pair with BWP-ID 2. This may provide benefits in terms of resource utilization flexibility and efficiency in that a SBFD configuration is not frequently changed but is changed selectively depending on gNB signaling, which may reduce gNB implementation complexity by avoiding frequent RF (e.g., RF filter, filtering, filtering coefficients) switching at gNB.

Operation 1 may be configured to a UE to perform based on Operation 1 (e.g., as a mode of operation), or Operation 1 may be pre-defined as a default mode of operation that the UE may follow/perform unless otherwise configured/indicated. Operation 1 may have one or more pre-requisite conditions that Operation 1 is to be used, for which at least one of following two paragraphs may apply:

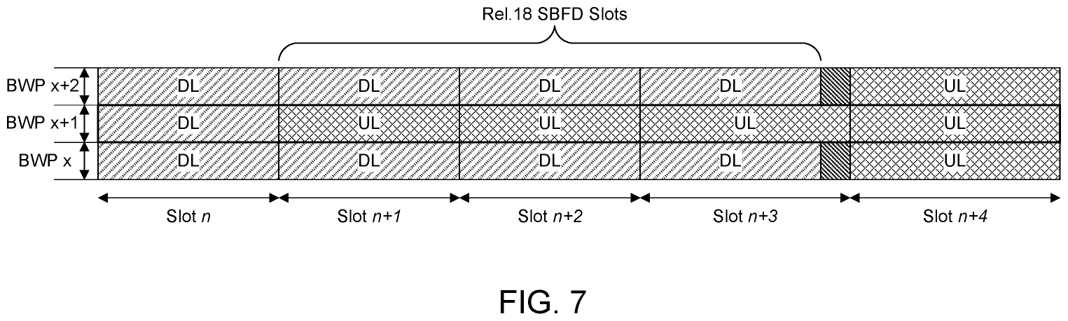

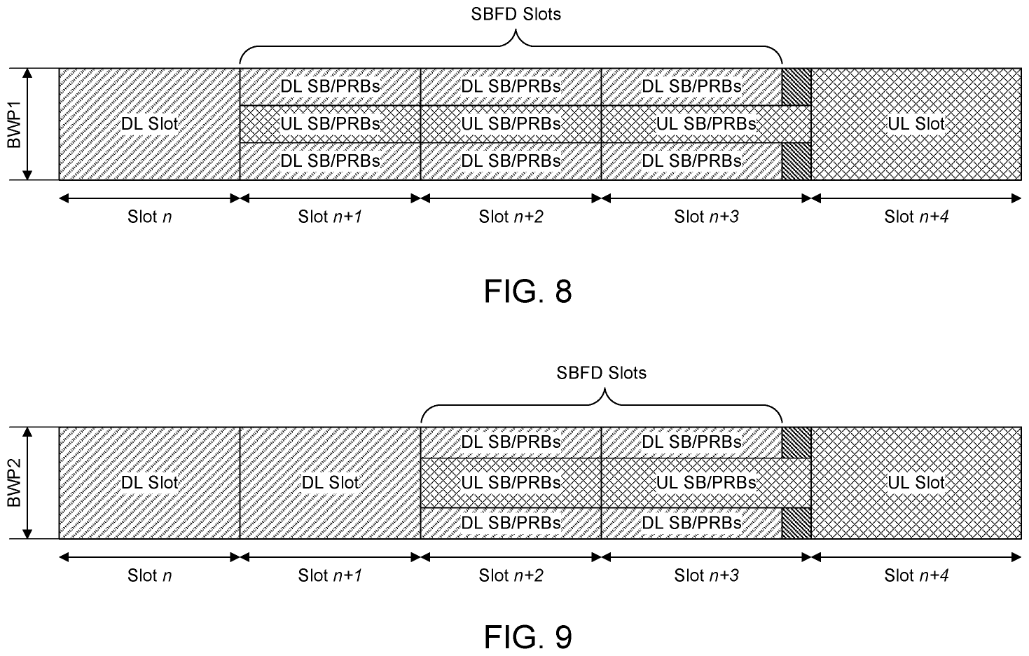

A first bandwidth (e.g., number of PRBs, whole frequency resource region) of the first BWP pair is less than or equal to a second bandwidth (e.g., number of PRBs, whole frequency resource region) of the second BWP pair as illustrated in FIGS. 8 and 9. It may mean the second bandwidth (of the second BWP pair) completely includes the first bandwidth (of the first BWP pair), which may guarantee, in terms of such a selective change of SBFD configuration, at least one subband (e.g., UL subband, and/or DL subband) of the first SBFD configuration is included (e.g., comprised, within a frequency region) in the second bandwidth (of the second BWP pair).

A first set of RBs corresponding to one or more subbands (e.g., UL subband(s), and/or DL subband(s)) of the first SBFD configuration of the first BWP pair is less than or equal to a second bandwidth (e.g., number of PRBs, whole frequency resource region) of the second BWP pair. It may mean the second bandwidth (of the second BWP pair) completely includes the first set of RBs, which may guarantee, in terms of such a selective change of SBFD configuration, at least one subband (e.g., UL subband, and/or DL subband) of the first set of the first SBFD configuration is included (e.g., comprised, within a frequency region) in the second bandwidth (of the second BWP pair).

The UE may receive (or determine) one or more pre-defined or pre-configured conditions that declare failure of maintaining the current SBFD configuration (e.g., the first SBFD configuration) in the new/switched BWP pair (e.g., the second BWP pair with BWP-ID 2) in response to the BWP switching command. The one or more conditions may include at least one of if the UL subband is not (fully) comprised within the switched BWP with BWP-ID 2), and if at least one of the one or more pre-requisite conditions is determined to be not satisfied

If the UE determines that the one or more pre-defined or pre-configured conditions that declare failure of maintaining the current (first) SBFD configuration are met (e.g., if the UL subband is not (fully) comprised within the switched BWP with BWP-ID 2), the UE may apply a fallback behavior which may be pre-defined or pre-configured based on at least one of following/applying a (legacy) ‘tdd-UL-DL-config-common’ and/or ‘tdd-UL-DL-config-dedicated’ for patterns of ‘D’, ‘U’ and/or ‘F’), and applying the UL subband to be truncated within (e.g., to be fit into) the switched second BWP with BWP-ID 2 (based on a pre-defined or pre-configured rule).

Operation 2: Based on the active BWP switching, e.g., at the second slot (or symbol), the UE may determine to change an associated SBFD configuration as well along with the BWP switching, at the same second slot (or symbol), e.g., following the same timeline for the active BWP switching.

In an example, when a UE operates in the first BWP pair with BWP-ID 1 and is operated based on the first SBFD configuration, in response to receiving a BWP switching command (e.g., via a DCI) indicating to switch to the second BWP pair with BWP-ID 2, e.g., to be occurred at the second slot (or symbol), the UE may determine to change/switch an associated SBFD configuration (as well) to the second SBFD configuration, at the same second slot (or symbol), e.g., which is associated with the second BWP pair with BWP-ID 2. The BWP switching command may be received via at least one of a UL-related DCI (e.g., format 0_1, 0_2) and a DL-related DCI (e.g., format 1_1, 1_2). This may provide benefits in terms of low complexity in UE implementation and simplifying the operational behavior.

The conditions mentioned with respect to Operation 1 may apply to Operation 2, as well.

The UE may be configured (e.g., indicated, or pre-defined/determined) to use both Operation 1 and Operation 2, meaning the application timeline may be shared (the same) for the active BWP switching and an associated SBFD configuration change/update (e.g., based on the Operation 2), but whether to change/switch the associated SBFD configuration (e.g., to the second SBFD configuration) may vary/be determined based on the Operation 1.

Operation 3: Based on the active BWP switching, e.g., at the second slot (or symbol), the UE may determine to change an associated SBFD configuration as well along with the BWP switching, at the same second slot (or symbol) plus a time offset parameter of L, e.g., following a timeline for the active BWP switching but applying a time offset L on top of the timeline. The UE may receive a configuration (or an indication) of a value of L, which may be a SBFD-application time (SAT), where L (e.g., a value of SAT) can be a positive value in time or a negative value in time (or zero, e.g., by default). The UE may perform a UE-capability reporting on the SAT, e.g., supported value(s) of SAT, and a value of L (SAT) may be UE-specifically configured/indicated (from a gNB) to the UE.

In an example, when a UE operates in the first BWP pair with BWP-ID 1 and is operated based on the first SBFD configuration, in response to receiving a BWP switching command (e.g., via a DCI) indicating to switch to the second BWP pair with BWP-ID 2, e.g., to be occurred at the second slot (or symbol), the UE may determine to change/switch, at the same second slot (or symbol) plus the time offset parameter of L, an associated SBFD configuration (as well) to the second SBFD configuration, e.g., which is associated with the second BWP pair with BWP-ID 2. The BWP switching command may be received via at least one of a UL-related DCI (e.g., format 0_1, 0_2) and a DL-related DCI (e.g., format 1_1, 1_2). Until reaching the application time by SAT, the UE should maintain the current (first) SBFD configuration (e.g., if the UL subband is comprised within the switched BWP with BWP-ID 2). If the UE determines that one or more pre-defined or pre-configured conditions that declare failure of maintaining the current (first) SBFD configuration are met (e.g., if the UL subband is not (fully) comprised within the switched BWP with BWP-ID 2), the UE may apply a fallback behavior, e.g., following/applying a (legacy) ‘tdd-UL-DL-config-common’ and/or ‘tdd-UL-DL-config-dedicated’ for patterns of ‘D’, ‘U’ and/or ‘F’), or applying the UL subband to be truncated within (e.g., to be fit into) the switched second BWP with BWP-ID 2 (based on a pre-defined or pre-configured rule). This may provide benefits in terms of low complexity in UE implementation and simplifying the operational behavior and provide flexibility to adjust an actual application time instance of applying/changing/switching the associated SBFD configuration.

The conditions mentioned with respect to Operation 1 may apply to Operation 3, as well.

The UE may be configured (e.g., indicated, or pre-defined/determined) to use Operation 1, Operation 2, and/or Operation 3. In an example, if the UE is configured (e.g., indicated, or pre-defined/determined) to use all three operations, the application timeline for changing an associated SBFD configuration may be determined based on a timeline for the active BWP switching plus the time offset parameter of L (e.g., based on Operation 2 and/or Operation 3), but whether to change/switch the associated SBFD configuration (e.g., to the second SBFD configuration) may vary/be determined based on Operation 1.

### 2 Configurable CLI Measurement Types and Window

### Configurable CLI Measurement Types

Cross Link Interference (CLI) may be referred to as an interference on a signal in one direction (e.g., DL or UL) from a signal in another direction (e.g., UL or DL), wherein a first CLI type may be a CLI interference occurred due to different TDD DL-UL configurations in neighboring cells and a second CLI type may be a CLI interference occurred due to leakage of signal in neighboring frequency subband.

In an embodiment, one or more CLI measurement types may be defined, determined, or used.

A first CLI measurement type (CLImeasType1) may refer to (e.g. be defined as) a CLI measurement performed on resources in legacy downlink slot(s)/symbol(s), wherein the legacy downlink slot/symbol may be a downlink (or uplink) slot/symbol wherein all resources in the slot/symbol are used, determined, or configured for downlink (or uplink) transmission. Herein, the legacy downlink slot/symbol may be interchangeably used with DL only slot/symbol, non-SBFD slot/symbol, and single direction slot/symbol.

A second CLI measurement type (CLImeasType2) may refer to a CLI measurement performed on resources in SBFD slot(s)/symbol(s), wherein the SBFD slot/symbol may be a downlink (or uplink) slot/symbol wherein a first subset of resources in frequency may be used, determined, or configured for a transmission in one direction (e.g., downlink or uplink) and a second subset of resources in frequency may be used, determined, or configured for a transmission in another direction (e.g., uplink or downlink).

A CLI measurement in CLImeasType2 may be performed on resources for downlink direction (e.g., the subset of resources for downlink), which may be referred to as CLImeasType2A.

A CLI measurement in CLImeasType2 may be performed on resources for uplink direction (e.g., the subset of resources for uplink), which may be referred to as CLImeasType2B.

A CLI measurement in CLImeasType2 may be performed on resources for both downlink and uplink direction, which may be referred to as CLImeasType2C.

A CLI measurement in CLImeasType2 may be performed on resources which may be used to mitigate CLI, for example, a gap resource which may be configured, determined, or used in between DL and UL resources. The CLI measurement on the gap resource may be referred to as CLImeasType2D.

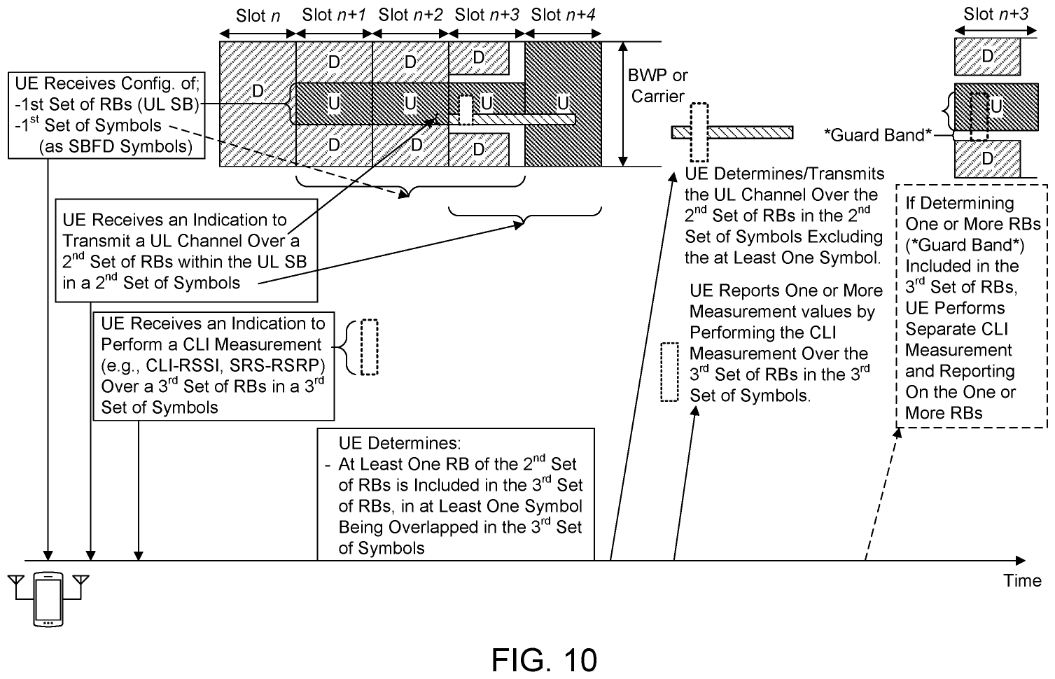

The resources for CLI measurement may be non-contiguous. For example, a CLI measurement resource based on the CLImeasType2A may be configured with non-contiguous allocation of RBs, e.g., across the two DL subbands on Slots n+1, n+2, or n+3 illustrated in FIG. 10. Therefore, with this non-contiguous CLI measurement resource, the UE may report (or transmit) one single CLI-RSSI (or other metric) report based on measuring both of the non-contiguous RBs, or the UE may report (or transmit) separated CLI-RSSI reports, each based on measuring each contiguous part of the non-contiguous CLI measurement resource, e.g., based on gNB's configuration or indication to do so.

A third CLI measurement type (CLImeasType3) may refer to a CLI measurement performed on resources in both legacy downlink slot/symbol and SBFD slot/symbol, wherein the CLI measurement in SBFD slot/symbol may be at least one of CLImeasType2A, CLImeasType2B, and CLImeasType2C.

A fourth CLI measurement type (CLImeasType4) may refer to a CLI measurement performed on resources in one or more resources (e.g., DL, UL, or SL resource) configured by gNB.

The one or more resources for CLI measurement configured by gNB may be one or more frequency resources nearby the frequency resources for another direction (e.g., edge RBs). The CLI measurement on the edge RBs may be referred to as CLImeasType4A

The one or more resources for CLI measurement configured by gNB may be zero-power resources (e.g., zero-power CSI-RS, zero-power CLI-RS). The CLI measurement on the zero-power resources may be referred to as CLImeasType4B

A UE may perform CLI measurement in one or more resources based on the configured, determined, or indicated CLI measurement type (e.g., based on at least one among CLImeasType1, CLImeasType2, CLImeasType2A, CLImeasType2B, CLImeasType2C, CLImeasType2D, CLImeasType3, CLImeasType4, CLImeasType4A, CLImeasType4B).

In an example, as illustrated in FIG. 10, a UE may receive configuration information indicating a first set of RBs (e.g., UL subband), within a bandwidth part or carrier, which is applicable for uplink transmission in a first set of symbols (e.g., SBFD symbols). FIG. 10 depicts an example of a CLI measurement (CLImeasType2B and/or 2D) on UL subband. The configuration information may also comprise one or more frequency locations on RBs for DL reception (DL subband), or the UE may identify that the DL subband(s) are located at least outside of the UL subband. The configuration information may also comprise one or more frequency locations on RBs being not applicable for DL reception nor UL transmission (e.g., “guard band”), e.g., in-between a UL subband and a DL subband, or the UE may identify that a guard band is located in-between the UL subband and the DL subband.

The UE may receive information (e.g., via DCI, MAC-CE, and/or RRC) indicating to transmit a UL channel or signal (e.g., PUSCH, PUCCH, SRS, PRACH, etc.) over a second set of RBs within the first set of RBs and in a second set of symbols that includes at least one symbol of the first set. The UE may transmit the UL channel or signal over the second set of RBs, e.g., on condition that the UE determine that any CLI measurement resource, type, and/or window is not overlapped with the scheduled or indicated transmission of the UL channel or signal.

The UE may receive information (e.g., via DCI, MAC-CE, and/or RRC) indicating to perform a CLI measurement (e.g., based on at least one among CLImeasType1, CLImeasType2, CLImeasType2A, CLImeasType2B, CLImeasType2C, CLImeasType2D, CLImeasType3, CLImeasType4, CLImeasType4A, CLImeasType4B discussed throughout the disclosure) over a third set of RBs in a third set of symbols.

In an example, the UE may receive the information indicating to perform the CLI measurement, based on the CLImeasType2B (as resources for uplink direction) and/or CLImeasType2D (as the gap resource, e.g., in between DL and UL resources/subbands), over a third set of RBs in a third set of symbols. The UE may determine that the at least one symbol is included (e.g., overlapped) in the third set of symbols and at least one RB of the second set of RBs is included in the third set of RBs in the at least one symbol. Based on the determining, the UE may transmit the UL channel or signal over the second set of RBs in the second set of symbols excluding the at least one symbol (e.g., due to being overlapped with the CLI measurement resource). This may provide benefits to have a higher-priority on the CLI measurement on the UL subband, as the UL subband may be generally to be used for UL transmissions but the CLI measurement resource may be configured in the UL subband where the UE may prioritize receiving or measuring the CLI measurement resource within the UL subband while dropping the scheduled or indicated UL transmission on the overlapped time. The UE may transmit (e.g., report) one or more measurement values (e.g., based on CLI-RSSI, SRS-RSRP, SINR, etc., discussed herein above) by performing the CLI measurement over the third set of RBs in the third set of symbols.

On condition that the UE may determine one or more RBs (e.g., “guard band”) which are included in the third set of RBs and are excluded in the second set of RBs, e.g., based on the CLImeasType2D, the UE may transmit (e.g., report) first one or more measurement values by performing first CLI measurement over the one or more RBs (e.g., within the guard band) in the third set of symbols, and may transmit (e.g., report) second one or more measurement values by performing second CLI measurement over the third set of RBs excluding the one or more RBs (e.g., within the UL subband) in the third set of symbols.

The examples discussed based on FIG. 10 are non-limiting examples, where the UE may (be configured to) determine to whether or not to transmit a scheduled or indicated UL channel or signal, based on determining an overlapped resource of a configured or indicated CLI measurement resource based on at least one among CLImeasType1, CLImeasType2, CLImeasType2A, CLImeasType2B, CLImeasType2C, CLImeasType2D, CLImeasType3, CLImeasType4, CLImeasType4A, CLImeasType4B. The examples discussed based on the FIG. 10 are non-limiting examples, where the UE may (be configured to) determine whether or not to receive a scheduled or indicated DL channel or signal, based on determining an overlapped resource of a configured or indicated CLI measurement resource based on at least one among CLImeasType1, CLImeasType2, CLImeasType2A, CLImeasType2B, CLImeasType2C, CLImeasType2D, CLImeasType3, CLImeasType4, CLImeasType4A, CLImeasType4B.

### Configurable CLI Measurement Window and UE Behaviors

In an embodiment, a UE may receive a dynamic indication of changing/switching an SBFD configuration (e.g., along with a BWP switching, or by an explicit indication from a gNB). In terms of network-wide operation (based on multiple geographically distributed cells and/or gNBs serving multiple different UEs), it may be beneficial to configure/indicate one or more UEs in the network to perform one or more cross-link interference (CLI) measurements within a time (and/or frequency) window which may be configured (or indicated) based on a coordination among cells (and/or gNBs) in the network.

In an embodiment, a UE (e.g., a UE of the one or more UEs) may be configured to perform CLI measurements for at least one type of CLI, e.g., based on at least one among CLImeasType1, CLImeasType2, CLImeasType2A, CLImeasType2B, CLImeasType2C, CLImeasType2D, CLImeasType3, CLImeasType4, CLImeasType4A, CLImeasType4B, over at least one timing configuration. Such timing configuration may be referred to as a “CLI measurement timing configuration”(CMTC) in the following.

A CMTC may be configured by at least one of a periodicity, offset with respect a slot or frame boundary, number of slots. The CMTC may also be configured by a bitmap pattern where each bit of the bitmap represents whether a corresponding slot belongs to the CMTC or not and the pattern is assumed to repeat indefinitely.

When performing CLI measurements in CMTC, the UE may de-prioritize transmission or reception of certain channels. For example, the UE may drop reception of PDSCH or transmission of PUSCH/SRS or PUCCH. Possibly, the UE may drop reception or transmission of such channels only in case of overlap in time and/or frequency domain with the resource used for a configured CLI measurement instance. The UE may de-prioritize other types of radio resource management (RRM) measurements such as RSRP, RSRQ, RSSI and the like. In some solutions, the prioritization between different types of RRM measurements and different types of CLI measurement may be explicitly configured using a priority level parameter. The priority may be configured per measurement object (or frequencies), RAT, or types. Different priorities may be configurable in different time instances to ensure a minimum amount of measurement for each type.

The UE may be configured to measure at least one CLI measurement instance. Each CLI measurement instance may be configured with at least one of a CLI measurement type such as defined in the previous section, a frequency-domain configuration, and a time-domain configuration or CMTC. The applicable frequency-domain configuration may include a starting (e.g. lowest) RB index, number of RB's and/or highest RB index, or a bitmap where each bit position may represents a RB. The frequency-domain configuration may be represented as a frequency domain resource allocation (FDRA) field as defined in legacy solutions. The applicable time-domain configuration may include a periodicity, offset, and/or bitmap where each bit position may represent a slot or symbol.

At least one frequency-domain configuration and/or time-domain configuration may implicitly be determined from a configuration aspect of SBFD, such as a set of slots in which a type of SBFD is applicable, a frequency range for UL or DL operation within a type of SBFD slot, UL/DL slot configuration, and the like.

Measurement quantity for a CLI instance may include interference level, received signal strength indicator (RSSI) and/or signal-to-interference ratio (SINR). In the latter case, the signal may be derived from RSRP measured on another measurement resource such as non-zero-power (NZP) CSI-RS or SS block. Measurement results may be in linear units or in dB units. Interference results and/or RSSI may be normalized by the number of resource blocks configured for the measurement. Such may be referred to as “normalized” interference level or RSSI The UE may be configured with at least one reporting configuration which may include criteria or events for the transmission of a measurement report containing CLI measurement results. Such events may include at least the following and may be configured along with supporting parameters (e.g. thresholds, offsets): (normalized) Interference/RSSI/SINR becomes higher (lower) than threshold for a CLI instance; and (normalized) Interference/RSSI/SINR from first CLI instance becomes higher (lower) than interference from second CLI instance plus an offset.

The latter event may be useful to help the network identify the source of interference (e.g. cross-link interference from neighbor cell versus adjacent-frequency interference from uplink portion of SBFD slot/symbol.

When a measurement report is transmitted, measurement results for each configured CLI instance may be included, where this behavior may be configured or indicated to the UE.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A wireless transmit/receive unit (WTRU), configured to:
receive information indicative of an uplink (UL) subband (SB);
receive an indication to perform a measurement on a first set of resource blocks (RBs) and a first set of symbols, wherein the first set of symbols include a first one or more subband non-overlapping full duplex (SBFD) symbol;
determine a first measurement for at least one RB in the first set of RBs that are outside the UL SB and a second measurement for at least one second RB in the first set of RBs that are outside the UL SB, wherein the at least one first RB and the at least one second RB are non-contiguous; and
transmit a message based on the first measurement and the second measurement.

2. The WTRU of claim 1, wherein the first measurement, the second measurement, or the first measurement and the second measurement are cross-link interference (CLI) measurements.

3. The WTRU of claim 2, wherein the second measurement comprises a CLI measurement for a second set of RBs comprising one or more RBs in the first set of RBs, and wherein the second set of RBs corresponds to a DL region, a guard band, an edge of the UL SB, or an edge of a DL region in the first one or more SBFD symbols.

4. The WTRU of claim 3, configured to:
determine the second set of RBs based on a received measurement type indication.

5. The WTRU of claim 1, configured to:
receive an indication to transmit on a UL channel in a third set of RBs and in a third set of symbols, wherein the third set of RBs is in the UL SB and the third set of symbols include one or more third SBFD symbols.

6. The WTRU of claim 5, configured to:
on condition that at least one symbol in the third set of SBFD symbols overlaps a symbol in the first set of SBFD symbols, transmit on the UL channel using the third set of RBs and a subset of the third set of symbols, wherein the subset includes one or more symbols in the third set of symbols that a) are not SBFD symbols or b) are SBFD symbols that do not overlap symbols in the first set of SBFD symbols.

7. A method at a wireless transmit/receive unit (WTRU), the method comprising:
receiving information indicative of an uplink (UL) subband (SB);
receiving an indication to perform a measurement on a first set of resource blocks (RBs) and a first set of symbols, wherein the first set of symbols include a first one or more subband non-overlapping full duplex (SBFD) symbol;
determining a first measurement for at least one RB in the first set of RBs that are outside the UL SB and a second measurement for at least one second RB in the first set of RBs that are outside the UL SB, wherein the at least one first RB and the at least one second RB are non-contiguous; and
transmitting a message based on the first measurement and the second measurement.

8. The method of claim 7, wherein the first measurement, the second measurement, or the first measurement and the second measurement are cross-link interference (CLI) measurements.

9. The method of claim 8, wherein the second measurement comprises a CLI measurement for a second set of RBs comprising one or more RBs in the first set of RBs, and wherein the second set of RBs corresponds to a DL region, a guard band, an edge of the UL SB, or an edge of a DL region in the first one or more SBFD symbols.

10. The method of claim 9, further comprising:
determining the second set of RBs based on a received measurement type indication.

11. The method of claim 7, further comprising:
receiving an indication to transmit on a UL channel in a third set of RBs and in a third set of symbols, wherein the third set of RBs is in the UL SB and the third set of symbols include one or more third SBFD symbols.

12. The method of claim 11, further comprising:
on condition that at least one symbol in the third set of SBFD symbols overlaps a symbol in the first set of SBFD symbols, transmitting on the UL channel using the third set of RBs and a subset of the third set of symbols, wherein the subset includes one or more symbols in the third set of symbols that a) are not SBFD symbols or b) are SBFD symbols that do not overlap symbols in the first set of SBFD symbols.

13. The WTRU of claim 2, wherein the WTRU is further configured to:
receive an indication to transmit on a UL channel in a third set of RBs and in a third set of symbols where the third set of RBs is in the UL SB and the third set of symbols include one or more third SBFD symbols.

14. The WTRU of claim 3, wherein the WTRU is further configured to:
receive an indication to transmit on a UL channel in a third set of RBs and in a third set of symbols where the third set of RBs is in the UL SB and the third set of symbols include one or more third SBFD symbols.

15. The WTRU of claim 4, wherein the WTRU is further configured to:
receive an indication to transmit on a UL channel in a third set of RBs and in a third set of symbols where the third set of RBs is in the UL SB and the third set of symbols include one or more third SBFD symbols.

19. The WTRU of claim 15, configured to:
on condition that at least one symbol in the third set of SBFD symbols overlaps a symbol in the first set of SBFD symbols, transmit on the UL channel using the third set of RBs and a subset of the third set of symbols, wherein the subset includes one or more symbols in the third set of symbols that a) are not SBFD symbols or b) are SBFD symbols that do not overlap symbols in the first set of SBFD symbols.

17. The method of claim 8, further comprising:
receiving an indication to transmit on a UL channel in a third set of RBs and in a third set of symbols where the third set of RBs is in the UL SB and the third set of symbols include one or more third SBFD symbols.

18. The method of claim 9, further comprising:
receiving an indication to transmit on a UL channel in a third set of RBs and in a third set of symbols where the third set of RBs is in the UL SB and the third set of symbols include one or more third SBFD symbols.

19. The method of claim 10, further comprising:
receiving an indication to transmit on a UL channel in a third set of RBs and in a third set of symbols where the third set of RBs is in the UL SB and the third set of symbols include one or more third SBFD symbols.

20. The method of claim 19, further comprising:
on condition that at least one symbol in the third set of SBFD symbols overlaps a symbol in the first set of SBFD symbols, transmitting the UL channel using the third set of RBs and a subset of the third set of symbols where the subset includes symbols in the third set of symbols that a) are not SBFD symbols or b) are SBFD symbols that do not overlap symbols in the first set of SBFD symbols.
